(19) United States
(12) Patent Application Publication
(10) Pub. No.: US 2009/0115304 A1
(43) Pub. Date: May 7, 2009

(54) BULB WITH ADJUSTABLE RADIATION ANGLE

(76) Inventor: Yulin WU, Foshan (CN)

Correspondence Address: MATTHIAS SCHOLL, 14781 MEMORIAL DRIVE, SUITE 1319, HOUSTON, TX, 77079, US

(21) Appl. No.: 12/198,909

(22) Filed: Aug. 27, 2008

(30) Foreign Application Priority Data
Nov. 6, 2007 (CN) 200710031364.6

(51) Int. Cl. H01J 1/88

(52) U.S. Cl. 313/292

(57) ABSTRACT

Provided is a bulb with an adjustable radiation angle, comprising a bulb base, a bulb body and a soft pipe; wherein the bulb base is connected to the bulb body via the soft pipe; and the soft pipe is capable of stretching and bending, so as to change a position of the bulb body and a radiation angle thereof. The invention makes it convenient to adjust a radiation angle of the bulb, and improves flexibility thereof.

### CROSS-REFERENCE TO RELATED APPLICATIONS

This application claims priority benefits to Chinese Patent Application No. 200710031364.6 filed Nov. 6, 2007, the contents of all of the aforementioned specifications are incorporated herein by reference.

### BACKGROUND OF THE INVENTION

1. Field of the Invention

This present invention generally relates to a lamp structure, and particularly to a bulb with an adjustable radiation angle.

2. Description of the Related Art

A bulb comprises a bulb base and a bulb body connected thereto. Conventionally, the bulb base and the bulb body is fixed connected with each other, if the bulb is plugged into a bulb holder, a radiation angle is fixed and is impossible to be adjusted.

### SUMMARY OF THE INVENTION

An object of the present invention is to provide a bulb with an adjustable radiation angle.

To achieve the above objective, in accordance with one embodiment of the invention, provided is a bulb with an adjustable radiation angle, comprising a bulb base, a bulb body and a soft pipe; wherein the bulb base is connected to the bulb body via the soft pipe; and the soft pipe is capable of stretching and bending, so as to change a position of the bulb body and a radiation angle thereof.

In a class of this embodiment, the soft pipe is a thin pipe made of plastics.

In a class of this embodiment, the soft pipe is a thin pipe made of aluminum.

In a class of this embodiment, the soft pipe is connected to the bulb base and the bulb body via adhesion.

In a class of this embodiment, the soft pipe is connected to the bulb base and the bulb body via welding.

The bulb with an adjustable radiation angle of the invention makes it convenient to adjust a radiation angle of the bulb, and improves flexibility thereof.

### BRIEF DESCRIPTION OF THE DRAWINGS

FIGS. 1-4 are schematic views of a bulb with an adjustable radiation angle of different embodiments of the invention;

FIG. 5 is a schematic view of the bulb with an adjustable radiation angle if a soft pipe bends; and

FIG. 6 is a schematic view of the bulb with an adjustable radiation angle if a soft pipe stretches.

### DETAILED DESCRIPTION OF THE INVENTION

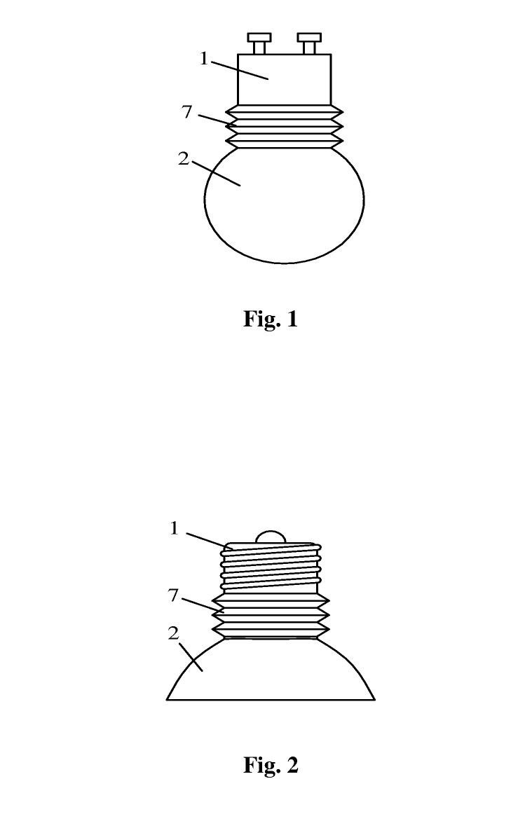

FIGS. 1-4 are schematic views of a bulb with an adjustable radiation angle of different embodiments of the invention.

As shown in FIG. 1-4, a bulb with an adjustable radiation angle of the invention comprises a bulb base 1, a bulb body 2 and a soft pipe 7. The bulb base 1 is connected to the bulb body 2 via the soft pipe 7. In this embodiment, the soft pipe 7 is a thin pipe made of plastics or aluminum, and is connected to the bulb base 1 and the bulb body 2 via adhesion or welding.

Referring to FIG. 1, the bulb base 1 of the first embodiment of the invention is a GU10 type.

Referring to FIG. 2, the bulb base 1 of the second embodiment of the invention is a screw type and the bulb body 2 is a reflector for receiving a plurality of LEDs.

Referring to FIG. 3, the bulb base 1 of the third embodiment of the invention is a GX5.3 type, and the bulb body 2 comprises a plastic shell 3, an aluminum profile 4, a plurality of LEDs and driving circuit boards (not shown).

Referring to FIG. 4, the bulb base 1 of the third embodiment of the invention is a screw type, and the bulb body 2 comprises a plastic shell 5 and a fluorescent glass tube 6. An electronic ballast is disposed in the plastic shell 5 (not shown).

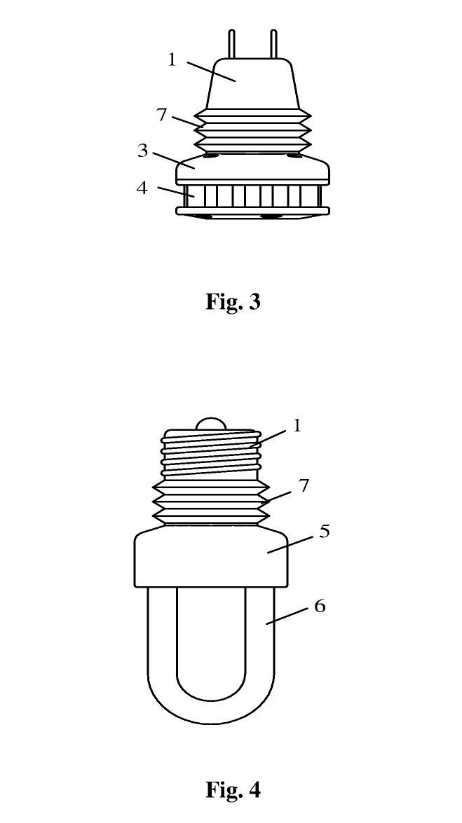

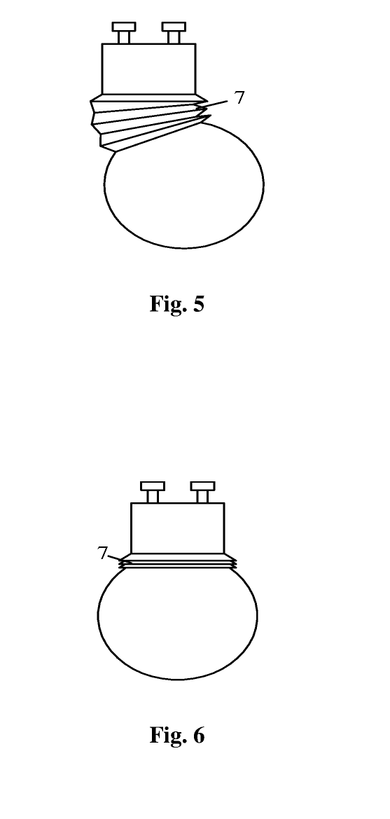

As shown in FIGS. 5 and 6, by stretching or bending the soft pipe 7, it is possible to change a position of the bulb body 2 and a radiation angle thereof.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A bulb with an adjustable radiation angle, comprising:
a bulb base;
a bulb body; and
a soft pipe;
wherein
said bulb base is connected to said bulb body via said soft pipe; and
said soft pipe is capable of stretching and bending, so as to change a position of said bulb body and a radiation angle thereof.

2. The bulb with an adjustable radiation angle of claim 1, wherein said soft pipe is a thin pipe made of plastics.

3. The bulb with an adjustable radiation angle of claim 1, wherein said soft pipe is a thin pipe made of aluminum.

4. The bulb with an adjustable radiation angle of claim 1, wherein said soft pipe is connected to said bulb base and said bulb body via adhesion.

5. The bulb with an adjustable radiation angle of claim 1, wherein said soft pipe is connected to said bulb base and said bulb body via welding.
